(19) United States
(12) Patent Application Publication
(10) Pub. No.: US 2014/0333752 A1
(43) Pub. Date: Nov. 13, 2014

(54) SYSTEM AND METHOD FOR ON-LINE MEASURING A BURDEN SURFACE IN A BLAST FURNACE

(71) Applicants: Zhengkai Gao, Beijing (CN); Chengping Zhao, Beijing (CN); Yong Gao, Beijing (CN); Tai Gao, Beijing (CN); Qian Gao, Beijing (CN)

(72) Inventors: Zhengkai Gao, Beijing (CN); Chengping Zhao, Beijing (CN); Yong Gao, Beijing (CN); Tai Gao, Beijing (CN); Qian Gao, Beijing (CN)

(21) Appl. No.: 14/362,541

(22) PCT Filed: Oct. 11, 2012
(86) PCT No.: PCT/CN2012/082799

§ 371 Date: Jun. 3, 2014

(30) Foreign Application Priority Data
Oct. 11, 2011 (CN) 201110307101.X

(51) Int. Cl. C21B 7/24; H04N 7/18

(52) U.S. Cl. CPC C21B 7/24; H04N 7/183
USPC 348/83

(57) ABSTRACT

The present invention discloses a system and method for on-line measuring a burden surface in blast furnace to get burden surface information. The system comprises laser emitter(s) disposed above the burden surface and emitting laser beam(s) to continuously scan at least one portion of the burden surface; a video camera configured to shoot burden surface images, each of which comprises a detection point pattern formed by the laser beam incident on the burden surface; an image processing device configured to receive the burden surface images transferred from the video camera and output the burden surface information. As compared with the prior art, the present invention may substantially reduce the cost of the measuring system and obtain burden surface information sufficiently accurate with a large number of actual detection points. Furthermore, the system for on-line measuring a burden surface in blast furnace according to the present invention may use less number of laser emitter (even one laser emitter), so it is more advantageous to minimize the system and may simplify laser emitter protective measures.

### FIELD OF THE INVENTION

The present invention generally relates to a field of measuring of blast furnaces, and particularly to a system and method for on-line measuring a burden surface in a blast furnace.

### BACKGROUND OF THE INVENTION

A metallurgical blast furnace usually operates in a closed state, and has an in-furnace environment of such as high temperature, high pressure, high dust content and high humidity. Hence, operators can not directly observe in-furnace information, e.g., burden surface in the furnace, charging process and operation states of in-furnace devices, and he has to deduce the in-furnace information from values of conventional detecting meters detecting parameters such as temperature, pressure, flow rate and so on.

In order to obtain the desired in-furnace information, infrared scanning and microwave scanning methods have been used to detect the interior of the blast furnace. However, these detections require applying complicated detecting and receiving devices and complicated computing system to process obtained data. In addition, those data all are distance information which needs to be restructured to form simulated image, and “WYSIWYG (What You See Is What You Get)” observation images may not be directly obtained.

The inventors of the present patent application proposed a detection device with an infrared image camera in Chinese Patent ZL02121548.0 and ZL200310122476.4, wherein observation images are obtained by receiving infrared light emitted from the burden itself in the blast furnace. However, during furnace charging process or in a state of a lower temperature of the burden, infrared light gets weak, and clear infrared image cannot be obtained so that the in-furnace information cannot be detected in real time. Hence, this type of detection device can only operate during a particular time period and under particular conditions.

The inventors of the present patent application inventively used laser beam detection device to obtain in-furnace information which was described in Chinese Patent ZL200610089415.6. In this patent, a plurality of laser beams simultaneously propagate in the in-furnace space and form a planar fan-shaped laser beam bundle (or two planar fan-shaped bundles which cross each other). A video camera is used to shoot the laser beam propagation pattern. As such, when an in-furnace equipment, such as a burden distributing device, passes through the fan-shaped laser beam bundle(s), propagation of the laser beam will be interrupted so as to change the laser light propagation pattern (i.e. use the laser light propagation pattern for tracing). Operation situations of the in-furnace equipment can be reflected from all the images shot by the video camera. When charged materials passing through the fan-shaped laser beam bundle, a similar effect is produced so that the burden material charging process can be also monitored.

Noticeably, the solution of Chinese Patent ZL200610089415.6 may also be used to obtain burden surface information (e.g., burden surface position and/or profile). When each laser beam in the planar fan-shaped laser beam bundle is incident onto the burden surface, a terminal point (or interception point) of each laser beam on the burden surface corresponds to an actual detection point of the burden surface. The terminal point (actual detection point) appears a “bright point” in the in-furnace image shot by the video camera. The terminal points of the plurality of laser beams on the burden surface correspond to a plurality of discrete bright points. The video camera shoots image containing these bright points at one moment. On the one hand, this image may be directly output to a display device so that operators can learn about profile and position of the current burden surface by observing the bright point distribution in the shot image (namely, “WYSIWYG”). On the other hand, by means of a computer, the bright point position in the image may be extracted from the image, and when in combination with the position of the video camera and angular information of shooting, corresponding actual positions of the bright points in the furnace may be computed. Further, a fitting algorithm may be applied to fit these discrete points into a continuous curve of burden surface profile, and the curve can be sent to a display device.

As known from further analysis, the Chinese Patent ZL200610089415.6 in fact uses laser beam, which is visible for a video camera with high penetrability, to “illuminate” the interior of the furnace. Certainly, due to excellent directionality of laser beams, the “illuminated” portion only appears beam lines and interception points in the laser beam bundle propagation path. Due to such an “illumination”, operators may observe the in-furnace information in a “WYSIWYG” manner via the video camera, which is obviously different with the previous distance-measuring detection means.

Another Chinese Patent ZL200710005609.8 also discloses a method of using laser beam to measure burden surface profile in blast furnace, wherein a laser ranging principle is used, and distance information of each measurement point on the burden surface is calculated by measuring a time differential from emission of a laser light to reception of the reflected laser beam, so as to obtain the profile of burden surface. This patent (ZL200710005609.8) does not use a device such as a video camera to obtain the aforesaid image of the “bright points” illuminated by the laser light, so the in-furnace information may not be observed in a “WYSIWYG” manner. The principles of the method of the patent are, in fact, similar to the above-mentioned other distance-measuring detection means such as microwave scanning method.

Reference is made back to the laser beam detection device of the Chinese Patent ZL200610089415.6. In this device, in order to obtain sufficient detection information, each planar fan-shaped laser beam bundle needs to consist of a sufficiently large number of laser beams, for example, usually 10 or more laser beams forming denser laser beam propagation patterns inside the furnace space (for detecting in-furnace equipments and burden charging process), and denser bright points on the burden surface (for detecting burden surface information). This needs a relatively large number of laser emitters. On the one hand, it makes the facility cost very high, and on the other hand, use of so many laser emitters makes the device volume very large. It is very difficult to keep these devices working normally for a long period of time under the severe in-furnace environment (such as high temperature, high pressure, high dust content and high humidity). Further, regarding detection of burden surface information, the “bright point” of each laser beam in the burden surface corresponds to an actual detection point, but the positions on the burden surface except for the actual detection points are not detected, or these positions may be fitted by an algorithm during subsequent image processing. If a detection result closer to the actual situation is to be obtained, more actual detection points are needed, so more laser emitters needed. It is apparent that the number of laser emitters cannot be expanded unlimitedly, so the actual detection points on burden surface can only be increased with limit.

### SUMMARY OF THE INVENTION

An object of the present invention is to overcome one or more drawbacks in the prior art and provide a system and method for on-line measuring a burden surface in a blast furnace.

According to one aspect of the present invention, there is provided a system for on-line measuring a burden surface in a blast furnace to detect burden surface information in the blast furnace, the system comprising:

a laser emitter disposed above blast furnace burden surface, and emitting a laser beam to continuously scan at least one portion of the burden surface;

a video camera configured to shoot burden surface images, each of which comprises a detection point pattern formed by the laser beam incident on the burden surface;

an image processing device configured to receive the burden surface image from the video camera and output the burden surface information.

According to another aspect of the present invention, this invention is to provide a method for on-line measuring burden surface in blast furnace to detect burden surface information comprising:

using a laser beam to continuously scan at least one portion of the burden surface inside the blast furnace; the laser beam being incident on the burden surface to form detection point pattern;

obtaining burden surface images, and each of the images comprising the detection point pattern;

obtaining the burden surface information based on the burden surface images.

The present invention has the following advantageous effects:

1) As compared with the Chinese Patent ZL200610089415.6, the number of the actual detection points on the burden surface using the present system and method for on-line measuring a burden surface in a blast furnace is only limited by laser scanning speed and a sampling frequency of the video camera. It is irrelevant to the number of the employed laser emitters. On the one hand, this may substantially reduce the cost of the system, and on the other hand, massive actual detection data may be generated from a large number of actual detection points. As such, burden surface information, including both burden surface images obtained through “WYSIWYG” and the generated burden surface profile curve, is more conforming to the actuality.

2) As compared with the Chinese Patent ZL200610089415.6, the system for on-line measuring a burden surface in a blast furnace according to the present invention may use a less number of laser emitter (even one laser emitter), so it is more advantageous to minimize the system volume and may simplify laser emitter protective measures.

### BRIEF DESCRIPTION OF DRAWINGS

FIG. 1 is a schematic view of a first embodiment according to the present invention;

FIG. 2 is a schematic view of a second embodiment according to the present invention;

FIG. 3 illustrates an example of a burden surface curve generated by burden surface images acquired by the video camera.

### DETAILED DESCRIPTION OF EMBODIMENTS

The present invention will be further described in detail with reference to drawings and embodiments.

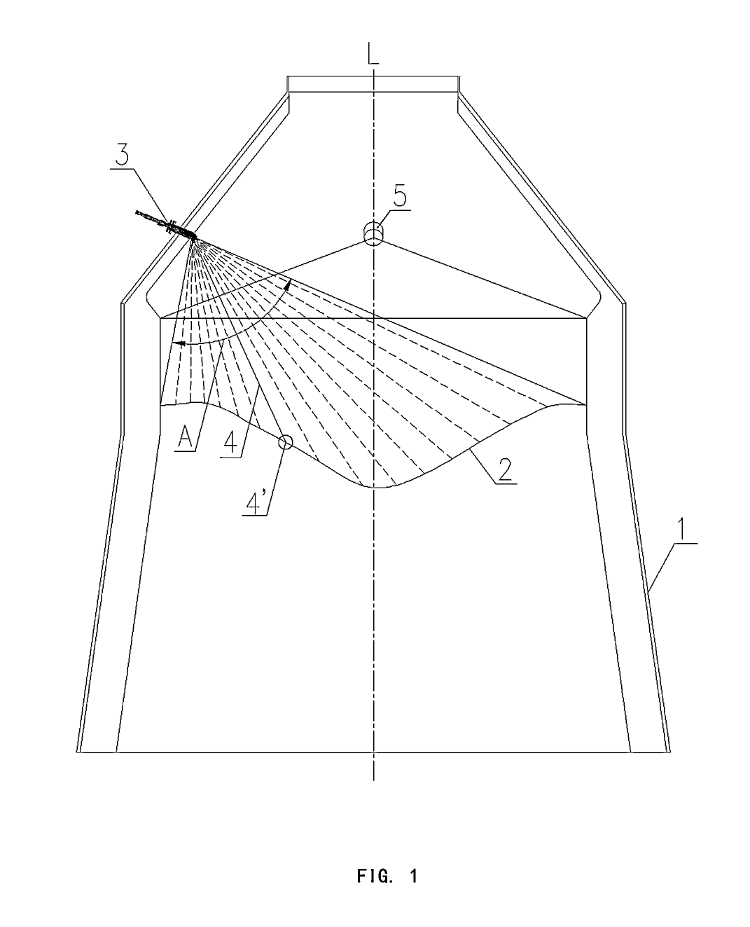

Referring to FIG. 1, a blast furnace 1 is generally in a central symmetrical shape around a central axis L, and a burden surface 2 of the charged burden is also usually in a substantially central symmetrical shape around the central axis L. In the cross-sectional view of FIG. 1, the central symmetry is represented as left-right symmetry around the axis L.

In the embodiment shown in FIG. 1, a system for on-line measuring burden surface in a blast furnace according to the present invention comprises a laser emitter 3 and a video camera 5 disposed above the burden surface 2. The laser emitter 3 and the video camera 5 can be positioned and/or disposed in the blast furnace 1 in a conventional manner, e.g., in a manner as stated in the Chinese Patent ZL200610089415.6.

The laser emitter 3 transmits one laser beam 4 which is “visible” for the video camera 5. Noticeably, “visible” for the video camera here means that a light sensing element used by the video camera 5 is sensitive to the frequency of the laser beam 4, i.e., the video camera 5 can capture the laser light with the frequency. In practice, the laser beam 4 can be either visible laser light or invisible laser light such as infrared laser light or ultraviolet laser light.

The laser emitter 3 is disposed properly so that the laser beam 4 can perform continuous scanning of at least one portion of or all over the burden surface 2. In the example shown in FIG. 1, the laser emitter 3 is disposed at the furnace wall. The solid line indicated by number label “4” represents a current position of the laser beam 4, and other laser beams drawn in dotted lines represent exemplary positions where the laser beam 4 might pass upon scanning, while two solid lines each at an end of the arrow A represent the scanning boundary of the laser beam 4.

In an embodiment, the laser emitter 3 is disposed to rotate around a pivot so that the laser beam 4 can scan the burden surface 2 in direction A. In another embodiment, the laser emitter 3 may be included in a laser scanner with a light deflecting device (e.g., a reflection mirror or a prism). By this device, when a laser beam is incident onto the deflecting device, and angle of the outgoing laser beam can be adjusted through rotating the deflecting device so that the laser beam 4 may scan the burden surface 2 in the direction A. In a further embodiment, which is not shown, the laser emitter may be disposed on a horizontal bar above the burden surface in the furnace, and the laser emitter 3 moves along the stationary horizontal bar or is moved with the bar together to scan the burden surface 2. In the example shown in FIG. 1, the laser beam 4 rotates along direction A to scan the burden surface 2 along with linear path (e.g., a diameter of the blast furnace 1). In other embodiments, the laser beam 4 may scan the burden surface 2 along other predetermined paths.

The video camera 5 is used to shoot images of the burden surface 2. The burden surface images are in fact comprised of a series of frame images obtained in a time sequence, and each frame image comprises a detection point pattern formed by the laser beam 4 being incident onto the burden surface 2. When the laser beam 4 scans the burden surface 2, the detection point pattern formed by a terminal point of the laser beam 4 on the burden surface 2 appears a bright point 4′ in the frame image, and the bright point 4′ is an actual detection point of the laser beam 4 on the burden surface 2. During scanning, the bright point 4′ moves continuously on the burden surface 2 as the laser beam 4 continuously moves, so as to form a scanning trajectory.

To enable the burden surface images shot by the video camera 5 to reflect burden surface profile changes, the video camera 5 should be disposed at a certain angle away from a plane where the scanning trajectory of the laser beam 4 lies. As shown in FIG. 1, the video camera 5 may be disposed at the furnace wall opposed to the plane where the scanning trajectory of the laser beam 4 lies.

The video camera 5 may output the burden surface images to an image processing device (not shown) outside the blast furnace 1. According to the present invention, the image processing device may process the burden surface images in many modes.

In one mode, the image processing device may comprise a display which directly shows the burden surface images to operators. As such, as the laser beam 4 scans continuously, the bright point 4′ advancing continuously can be seen in the display. Operators may learn about the burden surface information in real time, such as the profile and/or position of the burden surface by observing the displacement of the bright point 4′.

In another mode, the image processing device may further comprise a computing processing system. The computing processing system is configured to receive the burden surface images in real time, to superimpose the received current frame image with previously-received frame images, and to show the superimposed image in real time with the display. As such, as the laser beam 4 scans continuously, a pattern formed by a plurality of bright points 4′ in a corresponding plurality of frame images can be seen on the display in real time. If the sampling frequency of the video camera 5 is high enough, a burden surface profile curve extending constantly formed by the bright points 4′ in the plurality of frame images, can be seen in the display in real time. When the laser beam 4 scans the burden surface along a linear path, the superimposed image is a burden surface profile curve of the burden surface 2 along the linear path.

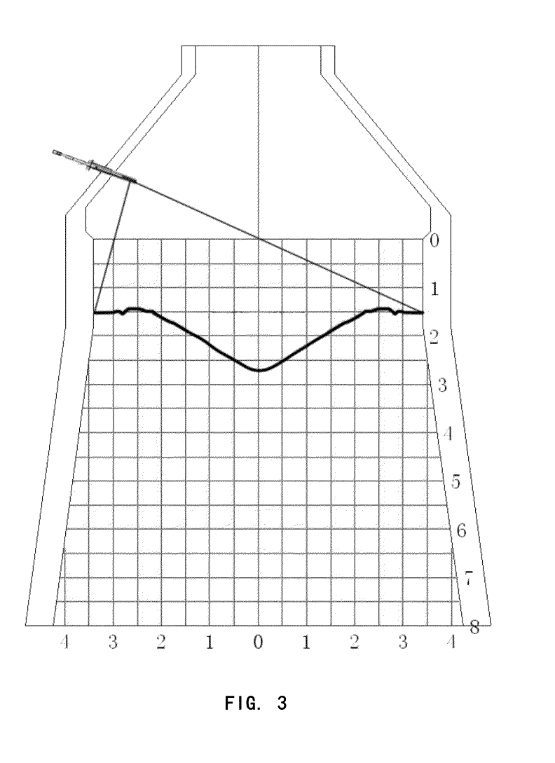

In a further mode, the computing processing system of the image processing device may process every burden surface image to obtain the position of the bright point in each frame image or selected plurality of frame images, and further may, in combination with parameters such as scanning direction and speed of the laser emitter and positional and angular information of the video camera, do computation to obtain the burden surface information data corresponding to the bright point 4′ in each frame image. The burden surface information data may comprise actual position data of an actual detection point represented by the bright point 4′ of the processed frame image. The processing system may further generate the burden surface profile curve from the computed burden surface information data, and output it to an output device such as a display. An example of the burden surface profile curve generated in this mode is shown in FIG. 3. This processing mode can be a real-time mode also. The processing system computes and processes the current frame image in real time and obtains the burden surface information data of the bright point 4′ in the current frame image, and generates burden surface profile curve in real time with burden surface information data obtained from the current frame image and the previous frame images. As such, when the generated burden surface profile curve is transferred and displayed in real time, with the laser beam 4 scanning continuously, a pattern formed by a plurality of actual detection points then will be shown. If the sampling frequency of the video camera 5 is high enough, a burden surface profile curve formed by the plurality of actual detection points extends constantly.

Since the laser beam 4 scans the burden surface 2 continuously, the number of the actual detection points (or bright points 4′) which can be shot by the video camera 5 is only limited by the laser scanning speed and the sampling frequency of the video camera. For example, as for a certain segment of continuous scanning trajectory, the laser beam 4 passes a horizontal distance of 0.5 meters in one second and the sampling frequency of the video camera is 24 frames/second, so 24 actual detection points will be shot in the distance of 0.5 meters. If the images captured by the video camera at the rate of 24 frames per second are directly shown in display, operators will see a scanning image where the bright point moves continuously. If the burden surface image is generated by the computing processing system, the number of the actual detection points which may be utilized by the computing processing system far exceeds that in the mode described in Chinese Patent ZL200610089415.6. In this case, image which is more conforming to the actual burden surface can be generated.

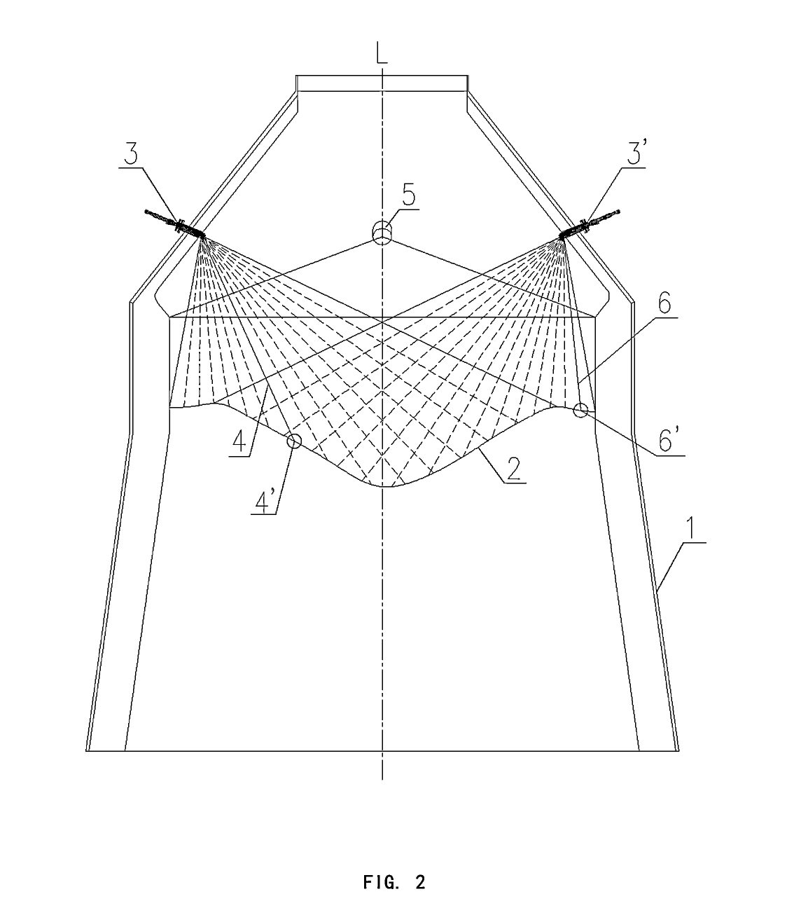

FIG. 2 is a schematic view of a second embodiment according to the present invention. In this Figure, the system for on-line measuring a burden surface in a blast furnace according to the present invention comprises two laser emitters 3 and 3′ which are disposed opposite to each other along a diameter of the blast furnace 1. As shown in FIG. 2, when there is a dead angle which cannot be scanned by the laser emitter 3 (e.g., a bright point 6′ corresponding to the current scanning position of a laser beam 6 generated from the laser emitter 3′) due to the shape of the burden surface 2, the laser emitter 3′ is used to scan to obtain the bright point 6′ and its adjacent detection points. In addition, when illuminating distance of the laser emitter 3 cannot meet the need of scanning the whole burden surface due to limitation of the laser emitter power, the laser emitter 3′ works together with laser emitter 3 and each emitter may respectively scan a portion of the burden surface (e.g., scanning until adjacent the center of the burden surface) adjacent thereto so as to complete the scanning of the whole burden surface. In an embodiment, the lasers emitter 3 and 3′ may scan the burden surface 2 at different time, whereupon each of the burden surface images obtained by the video camera will contain one bright point 4′ or 6′. In another embodiment, the laser emitter 3 and 3′ may scan the burden surface 2 simultaneously, whereupon each of the burden surface images obtained by the video camera 5 will contain two bright points 4′ and 6′.

In the embodiment shown in FIG. 2, the laser emitters and video camera may be disposed and the burden surface image may be processed by an image processing device in the same manner as in the embodiment shown in FIG. 1.

Those skilled in the art may appreciate that the system of on-line measuring a burden surface of a blast furnace according to the present invention may further comprise lasers disposed in other numbers and in other arrangement modes, so long as the lasers operate in a scanning mode and the video camera may obtain “WYSIWYG” burden surface images, which all fall within the scope covered by the intention of the present application.

What is claimed is:

1. A system for on-line measuring a burden surface in a blast furnace to detect burden surface information, comprising:
a laser emitter disposed above the burden surface and emitting a laser beam to continuously scan at least one portion of the burden surface;
a video camera configured to shoot burden surface images each of which comprises a detection point pattern formed by the laser beam incident on the burden surface;
an image processing device configured to receive the burden surface images from the video camera and to output burden surface information.

2. The system for on-line measuring a burden surface in a blast furnace according to claim 1, characterized in that, the burden surface information comprises a burden surface profile curve.

3. The system for on-line measuring a burden surface in a blast furnace according to claim 1, characterized in that, the laser emitter is disposed to be rotatable around a pivot, or the laser emitter is included in a laser scanner with light deflecting device.

4. The system for on-line measuring a burden surface in a blast furnace according to claim 1, characterized in that, the laser emitter is disposed on a horizontal bar in the blast furnace, and the laser emitter is movable along the horizontal bar or alternatively is movable with the bar to scan the burden surface.

5. The system for on-line measuring a burden surface in a blast furnace according to claim 1, characterized in that, the system comprises one said laser emitter.

6. The system for on-line measuring a burden surface in a blast furnace according to claim 1, characterized in that, the system comprises a plurality of said laser emitters disposed at different positions.

7. The system for on-line measuring a burden surface in a blast furnace according to claim 1, characterized in that, the system comprises two said laser emitters disposed opposite to each other in a diameter direction of the blast furnace.

8. The system for on-line measuring a burden surface in a blast furnace according to claim 1, characterized in that, the image processing device comprises a display device which directly displays the burden surface images.

9. The system for on-line measuring a burden surface in a blast furnace according to claim 1, characterized in that, the burden surface images comprise a series of frame images obtained in a time sequence, and the image processing device comprises:
a computing processing system configured to receive the burden surface images in real time, and superimpose the received current frame image with previously-received frame images;
a display device configured to display the superimposed image in real time.

10. The system for on-line measuring a burden surface in a blast furnace according to claim 9, characterized in that, the superimposed image comprises a burden surface profile curve formed by the detection point patterns.

11. The system for on-line measuring a burden surface in a blast furnace according to claim 1, characterized in that, the image processing device comprises a computing processing system configured to compute and process the burden surface images and obtain burden surface information data corresponding to the detection point patterns.

12. The system for on-line measuring a burden surface in a blast furnace according to claim 11, characterized in that, the image processing device further comprises output means, and the computing processing system further uses the burden surface information data to generate a burden surface profile curve and transfers it to the output means.

13. The system for on-line measuring a burden surface in a blast furnace according to claim 11, characterized in that, the burden surface images comprise a series of frame images obtained in a time sequence, and the computing processing system computes and processes the current frame image in real time, and obtains burden surface information data from the detection point pattern in the current frame image, and the computing processing system generates the burden surface profile curve in real time by means of the burden surface information data obtained from the current frame image and previous frame images.

14. A method for on-line measuring a burden surface in a blast furnace to detect burden surface information in the blast furnace, comprising:
using a laser beam to continuously scan at least one portion of the burden surface in the blast furnace; the laser beam being incident on the burden surface to form a detection point pattern;
obtaining burden surface images of the burden surface and each image comprises a detection point pattern;
obtaining the burden surface information based on burden surface images.

15. The method for on-line measuring a burden surface in a blast furnace according to claim 14, characterized in that, the burden surface information comprises a burden surface profile curve.

16. The method for on-line measuring a burden surface in a blast furnace according to claim 14, characterized in that, the burden surface images are directly output to a display means.

17. The method for on-line measuring a burden surface in a blast furnace according to claim 14, characterized in that, the burden surface images comprise a series of frame images obtained in a time sequence, a current frame image is superimposed in real time with previously-received frame images, and the superimposed image is output to the display means in real time.

18. The method for on-line measuring a burden surface in a blast furnace according to claim 17, characterized in that, the superimposed image comprises a burden surface profile curve formed by the detection point patterns.

19. The method for on-line measuring a burden surface in a blast furnace according to claim 14, characterized in that, the burden surface images are computed and processed to obtain burden surface information data corresponding to the detection point patterns, and the burden surface information data are used to form a burden surface profile curve to be transferred to an output means.

20. The method for on-line measuring a burden surface in a blast furnace according to claim 19, characterized in that, the burden surface images comprise a series of frame images obtained in a time sequence, and a current frame image is computed and processed in real time to obtains burden surface information data from the detection point pattern in the current frame image; and the burden surface profile curve is generated in real time by means of the burden surface information data obtained from the current frame image and previous frame images.
